(19) United States
(12) Patent Application Publication
(10) Pub. No.: US 2011/0298571 A1
(43) Pub. Date: Dec. 8, 2011

(54) RARE EARTH MAGNETIC MATERIALS COMPRISING GALLIUM AND METHODS OF MAKING THE SAME

(76) Inventor: Irena Skulj, Ljubljana (SI)

(21) Appl. No.: 13/115,156

(22) Filed: May 25, 2011

Related U.S. Application Data
(60) Provisional application No. 61/351,386, filed on Jun. 4, 2010.

(51) Int. Cl. H01F 7/02; B22F 1/00; B22F 3/12; H01F 41/02

(52) U.S. Cl. 335/302; 419/33

(57) ABSTRACT

Disclosed herein are rare earth permanent magnets comprising Ga, and a magnetic intermetallic compound. In one embodiment, the magnetic intermetallic compound comprises at least one rare earth element (R), at least three transition metal elements (T), with the balance comprising iron. Non-limiting examples of R include Y, Nd, Pr, and Dy; and non-limiting examples of T include Cu, AI, and Co. Methods of making the disclosed rare earth permanent magnets are also disclosed.

### CROSS-REFERENCE TO RELATED APPLICATION

This application claims the benefit of U.S. Provisional Application No. 61/351,386, filed Jun. 4, 2010, which is incorporated herein by reference in its entirety.

### THE FIELD OF INVENTION

The present invention relates to magnetic materials and permanent magnets based on rare earth magnets having exactly defined chemical composition comprising an addition of Gallium and its phase structure prepared by pulverisation, compaction and sintering process.

### SUMMARY OF THE INVENTION

There is disclosed a rare earth permanent magnet comprising Ga, and a magnetic compound. In one embodiment, the magnetic compound comprises at least one rare earth element (R), at least three transition metal elements (T), with the balance comprising iron. Non-limiting examples of R include Y, Nd, Pr, and Dy; and non-limiting examples of T include Cu, Al, and Co.

In one embodiment, R comprises Nd, Pr, and Dy, such as Nd in an amount ranging from 19.6 to 38.6 wt %; Pr in an amount ranging from 0.5 to 0.7 wt %; and Dy in an amount ranging from 2.5 to 11.5 wt %. In one embodiment, the amount of Dysprosium completely substitutes for Nd in all the phases. In another embodiment, the rare earth permanent magnet described herein comprises R in a total amount ranging from 31 to 32 wt %, such as 31.7 wt %.

Ga is typically present an amount ranging from 0.20 to 0.25 wt %, such as 0.22 wt %.

Other elements may be included in the rare earth permanent magnet described herein include, but are not limited to Co in an amount ranging from 2.0 to 4.0 wt %; Al in an amount ranging from 0.1 to 0.2%; Cu in an amount ranging from 0.1 to 0.2 wt %; B in an amount ranging from 0.8 to 1.0 wt %.

There is also disclosed a method of making the permanent magnet described herein, the method comprises:
forming a molten alloy of pure metals or binary alloys of R, T, Ga and iron;
forming a cast alloy by pouring the molten alloy into a form;
crushing the cast alloy; exposing the crushed alloy to hydrogen in a hydrogen furnace;
milling the crushed alloy with at least one additive to form a milled material;
compacting the milled material to form a compact; and
sintering the compact at a temperature above 1000° C.

### BRIEF DESCRIPTION OF THE DRAWINGS

FIG. 1 is a graph showing a temperature and pressure profile of a hydrogenation process according to the present invention.

FIG. 2 is a graph showing a temperature profile of the heat treatment process according to the present invention.

FIG. 3 is a graph showing demagnetization curves presenting magnetic properties of various alloys.

### DETAILED DESCRIPTION OF THE PROCESS

### Definitions

The following properties are used to compare permanent magnets produced and described herein:

Remanence (Bᵣ)—which measures the strength of the magnetic field;

Coercivity (H_{ci}) measures the material's resistance to becoming demagnetized;

Energy product (BHₘₐₓ) is the density of magnetic energy; and

Curie temperature (T_{c}) is the temperature at which the material loses its magnetism.

The rare earth magnets described herein have excellent remanence, coercivity and energy product values compared to currently available permanent magnets.

Therefore, there is disclosed a rare earth permanent magnet comprising Ga, and a magnetic compound comprising at least one rare earth element (R), at least three transition metal elements (T), such as Cu, Al, and Co, wherein R is chosen from Y, Nd, Pr, and Dy; Ga is present in an amount ranging from 0.20 to 0.25 wt %; and the balance is iron.

In another embodiment, the rare earth permanent magnet described herein comprises:

R in an amount of 31.7 wt %, wherein R comprises Nd, Pr, and Dy in the following amounts:

Nd in an amount ranging from 19.6 to 38.6 wt %;

Pr in an amount ranging from 0.5 to 0.7 wt %; and

Dy in an amount ranging from 2.5 to 11.5 wt;

Ga in an amount of 0.22 wt %;

Co in an amount of 3.0 wt %;

Al in an amount of 0.15 wt %;

Cu in an amount of 0.15 wt %;

B in an amount of 0.9 wt %; and

the balance is iron.

In one embodiment, the rare earth permanent magnet described herein exhibits Remanence (Bᵣ) ranging from 10-13 Gauss (G).

The rare earth permanent magnet described herein may also exhibit a BHₘₐₓ ranging from 25 to 40 mega gauss oersted (MGOe).

There is also disclosed a method of making a rare earth permanent magnet comprising Ga, and a magnetic compound comprising at least one rare earth element (R), at least three transition metal elements (T), wherein the method comprises:
forming a molten alloy of pure metals or binary alloys of at least two R elements, at least three T elements, Ga and iron; forming a cast alloy by pouring the molten alloy into a form;
crushing the cast alloy;
exposing the crushed alloy to hydrogen in a hydrogen furnace;
milling the crushed alloy with at least one additive to form a milled material;
compacting the milled material to form a compact; and
sintering the compact at a temperature ranging from 1080° C. to 1110° C.

Material Alloy

A non-limiting method of making a material alloy for magnets according to the present disclosure starts with choosing a desired composition. For example, an alloy having a composition as described in Table 1, containing up to 31.7 wt % of R and with inevitably contained impurities can be prepared. In the present disclosure, R denotes rare earth elements including Yttrium.

In the composition the amount of Dysprosium may vary and completely substitute Nd in all the phases. The variations in compositions can be seen in Table 2.

Casting

As stated, a material alloy with a desired composition is prepared by well know casting method. Pure metals or binary alloys are all together melted by a high-frequency melting furnace, to form a molten alloy. The temperature of the molten alloy is approximately 1350° C. when poured into a form. The form is cold and helps the molten alloy to quickly solidify. The solidified alloy would crush when the form gets opened.

Hydrogenation

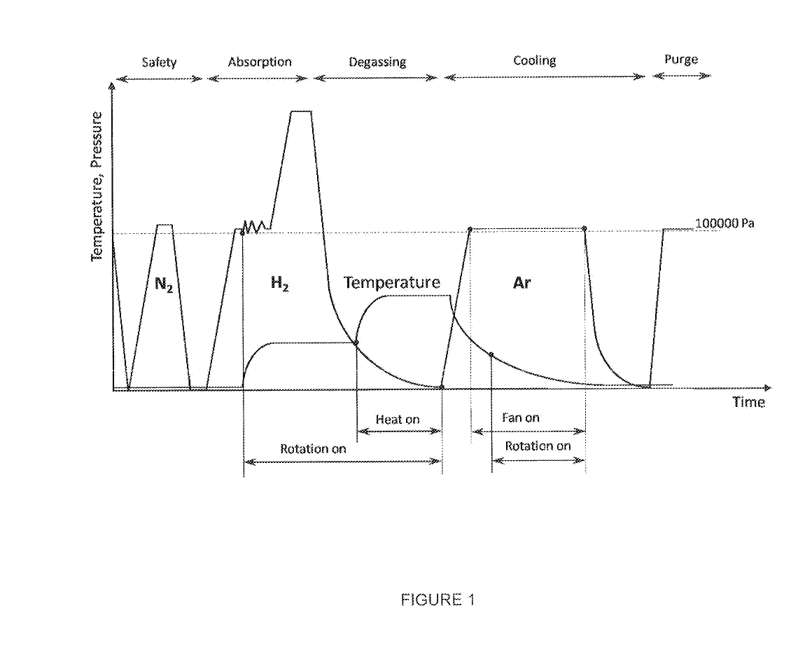

The coarsely crushed material alloy can then put into a barrel and placed into a Hydrogen furnace, which is then closed and evacuated until a desired vacuum was reached for at least 10 minutes. After which the furnace can be back filled with Hydrogen gas up to 1.5 bar. When Hydrogen absorption is initiated by the increased pressure, the temperature of the material rapidly increases up to 270° C. At the same time the pressure in the furnace starts dropping. Therefore, the furnace is being refilled until the pressure stabilizes. When the adsorption step has finished the furnace is then evacuated and heated up to 500° C. under vacuum. When the vacuum level reaches the minimal value the first step of the pulverisation is finished. The temperature and pressure profile of the hydrogenation process can be seen in FIG. 1.

After the hydrogenation process, the coarsely pulverised alloy powders are taken out from the barrel and stored in container under an inert gas atmosphere as not be in contact with the atmosphere. This prevents oxidation of the powder and thus serves to improve the magnetic properties of the resultant magnets.

By hydrogenation process, the rare earth alloy is pulverised to a size where about 15 wt % of the powders is finer than 45 μm and about 15 wt % is larger than 180 μm.

Milling Additive

Coarsely pulverised powder is mixed with a lubricant in an amount of 0.5 wt %, so that the alloy powder particles are coated with a milling additive. Zinc stearate may be used as a milling additive to improve the milling condition. By using the milling additive the oxidation of the powders may be partially suppressed.

Milling

Next, the coarsely pulverised powder in the first pulverisation process is finely milled with a jet mill. The jet mill consists of material feeder for feeding the coarsely pulverised powder in a milling area, a separator to separate fine already milled powders and let them travel in to a cyclone classifier from still too coarse powders to stay in the milling area, cyclone classifier to separate too fine powders from the milled powder and finally collecting cylinder for collecting powder having a predetermined particle size distribution classified with the classifying cyclone.

The feeder is equipped with a feeding screw connecting a container with a coarse powder with a milling area and is controlling the amount fed in to a milling area. Milling area is equipped with three nozzles through witch an inert gas is jet at high speed to create a milling atmosphere.

Compaction

The magnetic powder produced by a method described above is compacted in a magnetic field to align powders using compaction press. Aligned compact is demagnetised with a reverse field before ejecting from the press. Compacts are pressed under inert atmosphere to reach green density 4.3±0.15 g/cm³.

Heat Treatment

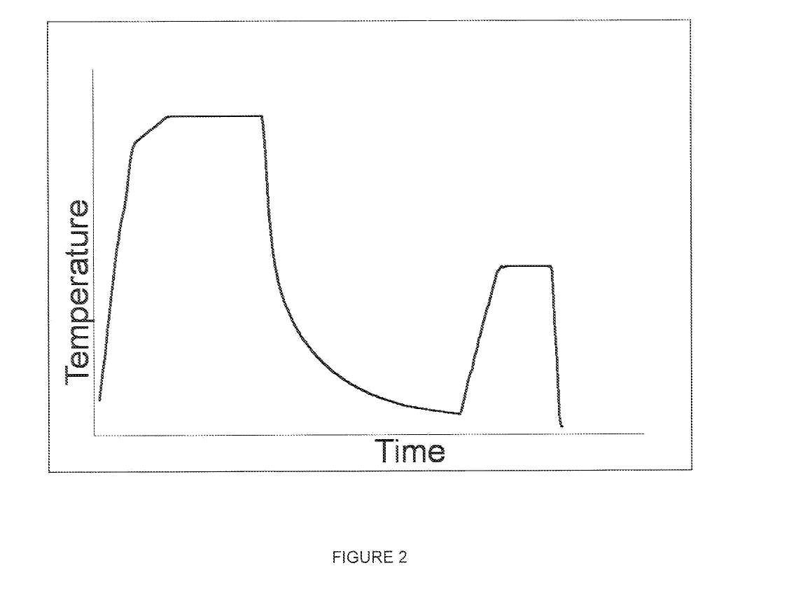

The compacts are then placed on the sintering tray and wrapped with a sintering foil. The sintering trays including the compacts are moved into a sintering furnace, where the compact is subject to a known heat treatment process at temperatures above 1000° C. to produce sintered magnets. Temperature profile of the heat treatment process can be seen in FIG. 2.

The heating rate is at first set to 800° C./h up to 1000° C. under the sintering temperature. For the last 100° C. the heating rate is set to 100° C./h. Sintering temperature varies in accordance with the quality of the final product. Sintering temperature varies between 1080° C. for lowest grade (Remag 26) and 1110° C. for highest grade (Remag 36). After sintering for 150 minutes the furnace is cooled. When the temperature dropped below 200° C., the furnace was again heated to 550° C. for 120 minutes.

Properties

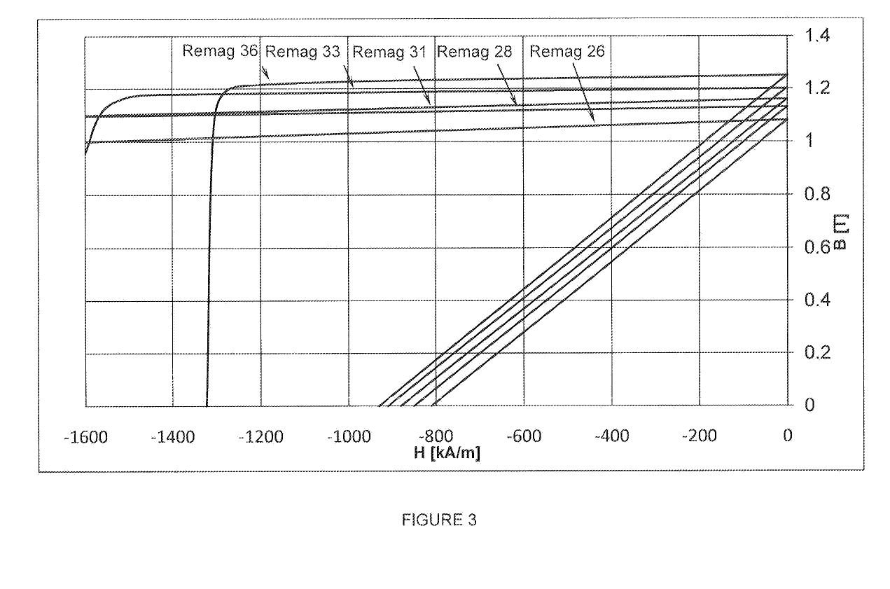

The permanent magnets of this invention may have magnetic properties as collected in Table 3 and presented in FIG. 3. Magnetic properties are collected from demagnetization curves drawn for each material grade. The compositions of each grade was determined using X-ray flourescence (XRF) spectrometer in combination with inductive coupled plasma (ICP) spectrometer.

TABLE 1
Composition of the material.

| wt % R | wt % Co | wt % B | wt % Ga | wt % Cu | wt % Al | wt % Fe |
|---|---|---|---|---|---|---|
| 31.70 | 3.00 | 0.90 | 0.22 | 0.15 | 0.15 | bal. |

TABLE 2
Variation of the R content that defines the quality.

| Quality | wt % Nd | wt % Pr | wt % Dy |
|---|---|---|---|
| Remag 26-36 | 19.60-28.60 | 0.60 | 2.50-11.50 |

TABLE 3
Magnetic properties.

| Sample | Br [G] | iHc [kOe] | BHₘₐₓ [MGOe] | T_{cp} [° C.] |
|---|---|---|---|---|
| Remag 33 | 10.8 | >28 | 28 | 220 |
| Remag 31 | 11.6 | >35 | 31 | 180 |
| Remag 28 | 12.0 | >20 | 32 | 150 |
| Remag 26 | 12.5 | >16 | 37 | 110 |

Unless otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A rare earth permanent magnet comprising Ga, and a magnetic compound comprising at least one rare earth element (R), at least three transition metal elements (T), wherein
R is chosen from Y, Nd, Pr, and Dy;
Ga is present in an amount ranging from 0.20 to 0.25 wt %; and
the balance is iron.

2. The rare earth permanent magnet of claim 1, wherein T comprises at least one of Cu, Al, and Co.

3. The rare earth permanent magnet of claim 1, wherein R is present in an amount ranging from 31 to 32 wt %.

4. The rare earth permanent magnet of claim 1, wherein R comprises Nd, Pr, and Dy.

5. The rare earth permanent magnet of claim 3, wherein:
Nd is present in an amount ranging from 19.6 to 38.6 wt %;
Pr is present in an amount ranging from 0.5 to 0.7 wt %; and
Dy is present in an amount ranging from 2.5 to 11.5 wt %.

6. The rare earth permanent magnet of claim 2, wherein:
Co is present in an amount ranging from 2.0 to 4.0 wt %;
Al is present in an amount ranging from 0.1 to 0.2 wt %
Cu is present in an amount ranging from 0.1 to 0.2 wt %
B is present in an amount ranging from 0.8 to 1.0 wt %; and
the balance is Fe.

6. The rare earth permanent magnet of claim 1, wherein said magnet exhibits Bᵣ ranging from 10-13 Gauss (G).

7. The rare earth permanent magnet of claim 1, wherein said magnet exhibits a BHₘₐₓ ranging from 25 to 40 mega gauss oersted (MGOe).

8. A rare earth permanent magnet comprising a magnetic compound comprising:
R in an amount of 31.7 wt %, wherein R comprises Nd, Pr, and Dy in the following amounts:
Nd in an amount ranging from 19.6 to 38.6 wt %;
Pr in an amount ranging from 0.5 to 0.7 wt %; and
Dy in an amount ranging from 2.5 to 11.5 wt;
Ga in an amount of 0.22 wt %;
Co in an amount of 3.0 wt %;
Al in an amount of 0.15 wt %;
Cu in an amount of 0.15 wt %;
B in an amount of 0.9 wt %; and
the balance is iron.

9. A method of making a rare earth permanent magnet, said magnet comprising Ga, and a magnetic compound comprising at least one rare earth element (R), at least three transition metal elements (T), wherein
R is chosen from Y, Nd, Pr, and Dy;
T is chosen from Cu, Al, and Co;
Ga is present in an amount ranging from 0.20 to 0.25 wt %; and
the balance is iron.

10. The method of claim 9, said method comprising:
forming a molten alloy of pure metals or binary alloys of at least two R elements, at least three T elements, Ga and iron;
forming a cast alloy by pouring the molten alloy into a form;
crushing the cast alloy;
exposing the crushed alloy to hydrogen in a hydrogen furnace;
milling the crushed alloy with at least one additive to form a milled material;
compacting the milled material to form a compact; and
sintering the compact at a temperature ranging from 1080° C. to 1110° C.
